(19) United States
(12) Patent Application Publication
(10) Pub. No.: US 2007/0111161 A1
(43) Pub. Date: May 17, 2007

(54) DIAMOND BURS FOR DENTISTRY

(75) Inventor: Ido Strauss, Kfar Yona (IL)

Correspondence Address: Dr. D'vorah Graeser;c/o Discovery Dispatch, 9003 Florin Way, Upper Marlboro, MD, 20772, US

(73) Assignee: STRAUSS & CO, Raanana (IL)

(21) Appl. No.: 11/164,292

(22) Filed: Nov. 17, 2005

(51) Int. Cl. A61C 3/06

(52) U.S. Cl. 433/166

(57) ABSTRACT

Diamond burs for dentistry are especially useful in application to porcelain and ceramics. Burs manufactured using a synthetic diamond grit of the type MBG® demonstrate exceptional useful properties in working with porcelain and hard ceramics including zirconia prosthodontics.

### FIELD OF THE INVENTION

The present invention is in the field of tools for dentistry. More specifically, the invention relates to burs especially useful for hard ceramics.

### BACKGROUND OF THE INVENTION

Three basic configurations are implemented in dental laboratories for the production of various types of fixed prosthodontics. Metals are used alone, usually for back teeth, and metals are used in combination with porcelain in what is known as PFM (porcelain fused noble metals). This configuration is based on fused external ceramics layers with internal metal bases. The third configuration includes ceramics without metal, referred to also as ceramic non-metal devices. These are more esthetically appealing as they can resemble the natural tooth due to their similar translucency properties. The prosthodontic brought in from the manufacturing laboratory typically comprise bridges and crowns. The prosthodontic pieces are implanted by the dentist into the previously prepared sites in the oral cavity. Thereafter, the dentist is required to perform various adjustments on the newly inserted pieces so as to fit them properly and restore function and esthetics of the dentures. Further treatments by the dentist requiring adjustments and even complete rupturing of a prosthodontic may be needed. For example, crown opening for accessing a root canal. The dentist typically uses diamond burs for making adjustments and for penetrating the prosthodontic piece. Finishing a prosthodontic piece involves trimming and polishing, and as with the other activities mentioned above involves use of diamond burs. General aspects of the structure of diamond burs are discussed in U.S. Pat. No. 5,823,775.

Applying diamond burs to porcelain and ceramics and expecially very hard ceramics such as zirconia is a cause for concern to dentists. Working with diamond burs causes chipping and cracking, also referred to as fracturing. In addition, the dentist working on such hard prosthodontics is often required to apply more pressure than is required in other bur operations, which can lead to reduced sensitivity in operation and thus potentially cause more damage.

### DETAILED DESCRIPTION OF THE PRESENT INVENTION

To prepare a diamond bur in accordance with the present invention, the diamond grit is attached to the shank of the bur in methods known in the art. Typically, the grit is attached to the shaft by electroplating using nickel. To overcome grinding, milling and tunneling applications in hard ceramics and porcelain, it was found that a diamond grit as described below provides for very efficient mechanical performance, as relates to porcelain and ceramic prosthodontics.

The best results are obtained with MBG® synthetic diamond grit type 620T produced by Diamond Innovations of 6325 Huntley Rd. Worthington, Ohio, USA 43085, having a mesh size of 230/270 US mesh standard, or in FEPA standard D 64 (FEPA=Federation of the European Producers of Abrasives), or 53-63 DIN standard (DIN=Deutches Institut Fur Normung).

The use of the above defined grit in the production of diamond burs allows for high efficiency grinding of prosthodontics, including hard ceramics porcelain, alumina and zirconia. The risk of chipping, resulting in chips being cut off the prosthetic piece, or cracking and breaking is greatly reduced. Because of the high efficiency, the dentist can apply less force as with other burs in working on such hard ceramics, and as a result the dentist can be more attentive to detail and precision.

1. A diamond bur for dentistry, the bur comprising a synthetic diamond grit of the size of 230/270 US mesh standard, wherein said grit is a MBG® 620T product.

2. A diamond bur for dentistry as in claim 1 wherein said bur is useful for work on ceramics and porcelain prosthodontics.

3. A method for treating dentistry prosthodontics, comprising:
Applying mechanical grinding using burs comprising synthetic diamond grit of the type MBG® 620T and of the size of 230/270 US mesh standard to a prosthodontic device.

4. The method of claim 3, wherein said prosthodontic device is selected from the group consisting of a bridge and a crown.

5. The method of claim 3, wherein said prosthodontic device comprises a material selected from the group consisting of ceramics, porcelain, alumina and zirconia.
